(19) United States
(12) Patent Application Publication
(10) Pub. No.: US 2016/0330055 A1
(43) Pub. Date: Nov. 10, 2016

(54) APPARATUS FOR AND METHOD OF AN INTERLEAVER AND A TONE MAPPER

(71) Applicant: Samsung Electronics Co., Ltd., Gyeonggi-do (KR)

(72) Inventor: Fei TONG, Bassingbourn (GB)

(73) Assignee: Samsung Electronics Co., Ltd.

(21) Appl. No.: 14/877,586

(22) Filed: Oct. 7, 2015

Related U.S. Application Data
(60) Provisional application No. 62/158,294, filed on May 7, 2015.

(51) Int. Cl. H04L 27/26; H04W 84/12; H04W 28/08; H04J 11/00

(52) U.S. Cl. CPC H04L 27/2601; H04J 11/00; H04W 84/12; H04W 28/08

(57) ABSTRACT

An apparatus and method for an interleaver and a tone mapper are provided. The apparatus for the interleaver includes a register, including an input, a first output, a second output, a third output, and a fourth output; a first interleaver block, including an input and an output; a second interleaver block, including an input and an output; a third interleaver block, including an input and an output; a fourth interleaver block, including an input and an output; a matrix, including a first input connected to the output of the first interleaver block, a second input connected to the output of the second interleaver block, a third input connected to the output of the third interleaver block, a fourth input connected to the output of the fourth interleaver block, and an output; and a permuter, including an input connected to the output of the matrix, and an output.

### PRIORITY

This application claims priority under 35 U.S.C. §119(e) to a U.S. Provisional Patent Application filed on May 7, 2015 in the United States Patent and Trademark Office and assigned Ser. No. 62/158,294, the entire contents of which are incorporated herein by reference.

### BACKGROUND OF THE DISCLOSURE

1. Field of the Disclosure

The present disclosure relates generally to an apparatus for and a method of an interleaver and a tone mapper, and more particularly, to an apparatus for and a method of an interleaver and a tone mapper in accordance with the Institute of Electrical and Electronics Engineers (IEEE) 802.11ax standard.

2. Description of the Related Art

The IEEE 802.11 standard is a set of media access control (MAC) and physical layer (PHY) specifications for implementing wireless local area network (WLAN) computer communication in the 2.4, 3.6, 5, and 60 GHz frequency bands. The IEEE 802.11 standard and amendments thereto provide the basis for wireless network products using wireless fidelity (Wi-Fi). An amendment to the IEEE 802.11 standard is viewed as its own standard, because an amendment identifier concisely denotes its capabilities.

The IEEE 802.11ac standard is an amendment to IEEE 802.11 standard that includes wider channels (i.e., 80 MHz or 160 MHz versus 40 MHz in the IEEE 802.11n standard) in the 5 GHz band, more spatial streams (i.e., up to eight streams versus four streams in the IEEE 802.11n standard), higher-order modulation (up to 256 Quadrature Amplitude Modulation (256-QAM) vs. 64-QAM in the IEEE 802.11n standard), and the addition of multi-user multiple input multiple output (MU-MIMO).

The IEEE 802.11ax standard is a proposed improvement to the IEEE 802.11ac standard to increase the efficiency of WLAN networks (e.g. Orthogonal Frequency Division Multiplexing (OFDM) PHY) by increasing the throughput by four times (4×) over the IEEE 802.11ac standard.

The IEEE 802.11ax standard is expected to reduce the subcarrier spacing to a quarter of the subcarrier spacing defined in the IEEE 802.11ac standard. This will increase the maximum number of subcarriers (e.g. Fast Fourier Transform (FFT) size) per segment from 256 to 1024. The interleaver design (pattern) and tone mapper are parameterized by the number of data subcarriers, which is linked to the FFT size. The interleaver for the IEEE 802.11ac standard only processes up to 234 data subcarriers per segment case. Since the maximal number of data subcarriers for the IEEE 802.11ax standard will increase by four times over the IEEE 802.11ac standard, there is a need for an interleaver in accordance with the IEEE 802.11ax standard.

### SUMMARY

An aspect of the present disclosure is to provide a method of and an apparatus for an interleaver and a tone mapper.

An aspect of the present disclosure is to provide a method of and an apparatus for an interleaver and a tone mapper in accordance with the IEEE 802.11ax standard for the same physical layer convergence procedure (PLCP) protocol data unit (PPDU) bandwidth as the IEEE 802.11ac standard.

Another aspect of the present disclosure is to provide a method of and an apparatus for a two-stage interleaver and tone mapper, where, in the first stage, bits carried in each OFDM symbol are partitioned into four sub blocks, and in the second stage, output bits from the four sub blocks are permuted using a block-wise permutation.

Another aspect of the present disclosure is to provide a method of and an apparatus for a two-stage interleaver and tone mapper, where in the first stage, bits carried in each OFDM symbol are partitioned into four sub blocks, where each of the four sub blocks is an interleaver in accordance with the IEEE 802.11ac standard.

Another aspect of the present disclosure is to provide a method of and an apparatus for a two-stage interleaver, where in the second stage, consecutive N_{bpscs} bits, which will be loaded to the same QAM symbol, will remain consecutive, and where two consecutive N_{bpscs} bits will be separated by 3×N_{bpscs} bits.

Another aspect of the present disclosure is to provide a method of and an apparatus for a two-stage interleaver and tone mapper that may require less memory and reduce latency, where in the first stage, bits carried in each OFDM symbol are partitioned into four sub blocks, where bit level permutation is within each sub block, and where in the second stage, the order of bits within each sub block does not change.

In accordance with an aspect of the present disclosure, an apparatus for an interleaver is provided. The apparatus includes a register, including an input, a first output, a second output, a third output, and a fourth output; a first interleaver block, including an input connected to the first output of the register, and an output; a second interleaver block, including an input connected to the second output of the register, and an output; a third interleaver block, including an input connected to the third output of the register, and an output; a fourth interleaver block, including an input connected to the fourth output of the register, and an output; a matrix, including a first input connected to the output of the first interleaver block, a second input connected to the output of the second interleaver block, a third input connected to the output of the third interleaver block, a fourth input connected to the output of the fourth interleaver block, and an output; and a permuter, including an input connected to the output of the matrix, and an output.

In accordance with another aspect of the present disclosure, a method of an interleaver is provided. The method includes receiving, by a register, a symbol; interleaving, by a first interleaver block, a first quarter of the symbol; interleaving, by a second interleaver block, a second quarter of the symbol; interleaving, by a third interleaver block, a third quarter of the symbol; interleaving, by a fourth interleaver block, a fourth quarter of the symbol; storing, by a matrix, the interleavings of the first interleaver block, the second interleaver block, the third interleaver block, and the fourth interleaver block; and permuting, by a permuter, the interleavings stored in the matrix.

In accordance with another aspect of the present disclosure, a chipset for an interleaver is provided. The chipset is configured to receive, by a register, a symbol; interleave, by a first interleaver block, a first quarter of the symbol; interleave, by a second interleaver block, a second quarter of the symbol; interleave, by a third interleaver block, a third quarter of the symbol; interleave, by a fourth interleaver block, a fourth quarter of the symbol; store, by a matrix, the interleavings of the first interleaver block, the second interleaver block, the third interleaver block, and the fourth interleaver block; and permute, by a permuter, the interleavings stored in the matrix.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram of an interleaver according to an embodiment of the present disclosure;

FIG. 2 is a flowchart of a method of an interleaver according to an embodiment of the present disclosure;

FIG. 3 is a block diagram of a tone mapper according to an embodiment of the present disclosure; and

FIG. 4 is a flowchart of a method of a tone mapper according to an embodiment of the present disclosure.

### DETAILED DESCRIPTION OF EMBODIMENTS OF THE PRESENT DISCLOSURE

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist the overall understanding of the embodiments of the present disclosure. Therefore, it should be apparent to those skilled in the art that various changes and modifications of the embodiments described herein may be made without departing from the scope and spirit of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout the specification.

The present disclosure may have various modifications and various embodiments, among which embodiments will now be described in detail with reference to the accompanying drawings. However, it should be understood that the present disclosure is not limited to the embodiments, but includes all modifications, equivalents, and alternatives within the spirit and the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate existence of a feature, a number, a step, an operation, a structural element, parts, or a combination thereof, and do not exclude the existence or probability of addition of one or more other features, numerals, steps, operations, structural elements, parts, or combinations thereof.

Unless defined differently, all terms used herein, which include technical terminologies or scientific terminologies, have the same meanings as those understood by a person skilled in the art to which the present disclosure belongs. Such terms as those defined in a generally used dictionary are to be interpreted to have the same meanings as the contextual meanings in the relevant field of art, and are not to be interpreted to have ideal or excessively formal meanings unless clearly defined in the present disclosure.

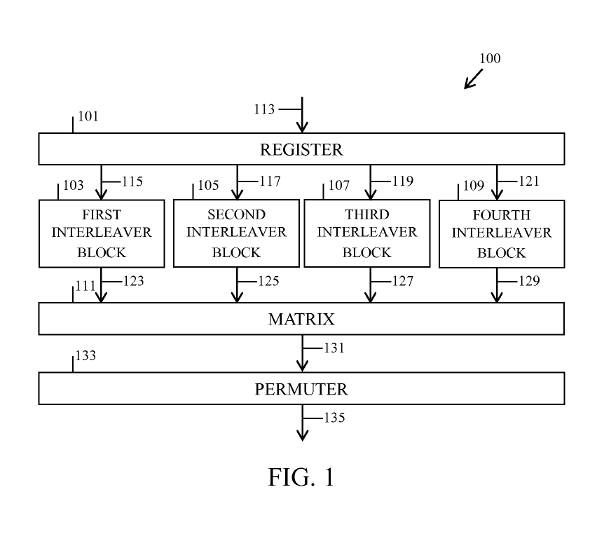

FIG. 1 is a block diagram of an interleaver 100 according to an embodiment of the present disclosure.

Referring to FIG. 1, the apparatus 100 includes a register 101, a first interleaver block 103, a second interleaver block 105, a third interleaver block 107, a fourth interleaver block 109, a matrix 111, and a permuter 133.

The register 101 includes an input 113 for receiving a symbol of bit length 4×N, a first output 115, a second output 117, a third output 119, and a fourth output 121, where each of the first output 115, the second output 117, the third output 119, and the fourth output 121 outputs N bits of the received 4×N bit symbol. In an embodiment of the present disclosure, the received symbol is an OFDM symbol. However, the present disclosure is not limited to receiving an OFDM symbol.

In an embodiment of the present disclosure, the received symbol may be an OFDM symbol that is 4×N_{cbps} bits as in the IEEE 802.11ax standard, where N_{cbps} is a number of encoded bits transmitted in one OFDM symbol for the IEEE 802.11ac standard, and where 4×N_{sd} is a number of data subcarriers in one OFDM symbol of the present disclosure as in the IEEE 802.11ax standard, which is four times greater than the OFDM symbol of the IEEE 802.11ac standard. In this case, each of the first output 115, the second output 117, the third output 119, and the fourth output 121 of the register 101 outputs N_{cbps} bits of the 4×N_{cbps} bits received by the register 101. However, the present disclosure is not limited thereto.

Each of the first interleaver block 103, the second interleaver block 105, the third interleaver block 107, and the fourth interleaver block 109 includes an input connected to the first output 115, the second output 117, the third output 119, and the fourth output 121, respectively, for receiving N bits from one of the outputs of the register 101. In an embodiment of the present invention, each of the first interleaver block 103, the second interleaver block 105, the third interleaver block 107, and the fourth interleaver block 109 may receive N_{cbps} bits from the first output 115, the second output 117, the third output 119, and the fourth output 121 of the register 101.

In FIG. 1, the first interleaver block 103, the second interleaver block 105, the third interleaver block 107, and the fourth interleaver block 109 sequentially receive 4×N bits from the first output 115, the second output 117, the third output 119, and the fourth output 121 of the register 101. However, the present invention is not limited thereto.

Each of the first interleaver block 103, the second interleaver block 105, the third interleaver block 107, and the fourth interleaver block 109 may implement the interleaving function defined in the IEEE 802.11ac standard. However, the present disclosure is not limited thereto.

In the IEEE 802.11ax standard, 4×N_{cbps} is the number of encoded bits transmitted in one OFDM symbol in accordance with the IEEE 802.11ax standard, and 4×N_{sd} is the number of data subcarriers in one OFDM symbol in accordance with the IEEE 802.11ax standard.

Interleaving in the IEEE 802.11ax standard (i.e., for a 4×N_{sd} sized OFDM symbol) is performed in two stages. In the first interleaving in the first stage, the encoded bits are grouped into four blocks, and k^{th} (input index) bit belongs to block

$$m = ⌊ \frac{k}{{N}_{cbps}} ⌋ ,$$

k∈[0,4·N_{cbps}−1], m∈[0,3]. Each block is interleaved using the interleaving pattern defined in accordance with the IEEE 802.11ac standard using the quadruplet (N_{sd},N_{bpscs},iₛₛ,Nₛₛ), where N_{cbps} is a number of encoded bits transmitted in one OFDM symbol in accordance with the IEEE 802.11ac standard, N_{bpscs} is a number of bits carried in one subcarrier, which indicates a modulation order, N_{sd} is a number of data subcarriers in one OFDM symbol in accordance with the IEEE 802.11ac standard, Nₛₛ is a number of spatial streams, iₛₛ is a spatial stream index, where interleaving is done per spatial stream separately, and fₛ is a subcarrier spacing in accordance with the IEEE 802.11ac standard.

The interleaving function of the IEEE 802.11ac standard includes three permutations. The first permutation is given by the rule shown in Equation (1) below.

$$i = {N}_{ROW} ( k mod {N}_{COL} ) + ⌊ \frac{k}{{N}_{COL}} ⌋ , k = 0 , 1 , … , {N}_{cbpssi} - 1 , \qquad ( 1 )$$

where i is an index of an interleaved bit after the first permutation, N_{ROW} is a row number of rows in the interleaver function, k is an index of a bit before being interleaved, N_{COL} is a number of columns in the interleaver function, N_{cbpssi} is a number of encoded bits per symbol per spatial stream per binary convolution code interleaver block, and [x] is a floor function that provides the largest integer less than or equal to x.

The second permutation of the IEEE 802.11ac standard is given by the rule shown in Equation (2) below.

$$j = s ⌊ \frac{i}{s} ⌋ + ( i + {N}_{cbpssi} - ⌊ \frac{{N}_{COL} \times i}{{N}_{cbpssi}} ⌋ ) mod s , \\ i = 0 , 1 , … , {N}_{cbpssi} - 1 , \qquad ( 2 )$$

where j is an index of an interleaved bit after the second permutation, and s is a number of bits assigned to a single axis of a constellation point in a spatial stream.

If 2≦Nₛₛ≦4, the third permutation of the IEEE 802.11ac standard is a frequency rotation applied to the output of the second permutation as shown in Equation (3) below.

$$r = \{ j - [ ( 2 ( {i}_{ss} - 1 ) ) mod 3 + 3 ⌊ \frac{{i}_{ss} - 1}{3} ⌋ ] \times {N}_{ROT} \times {N}_{bpscs} \} mod {N}_{cbpssi} , \\ j = 0 , 1 , … , {N}_{cbpssi} - 1 , {i}_{ss} = 1 , 2 , … , {N}_{ss} , \qquad ( 3 )$$

where r is an index of an interleaved bit after the third permutation, and N_{ROT} is a parameter for the frequency rotation.

If Nₛₛ>4, the third permutation of the IEEE 802.11ac standard is a frequency rotation applied to the output of the second permutation as shown in Equation (4) below.

r={j−J(iₛₛ)×N_{ROT}×N_{bpscs}}mod N_{cbpssi},j=0,1, . . . ,N_{cbpssi}−1,iₛₛ=1,2, . . . ,Nₛₛ, (4)

where r is an index of an interleaved bit after the third permutation, and J(iₛₛ) is an integer.

The parameterized permutation function defined by the IEEE 802.11ac standard is denoted as π_{ac}(N_{sd},N_{bpscs},lₛₛ,Nₛₛ,i) i ∈[0, N_{cbps}−1], lₛₛ∈[0, Nₛₛ−1]. This represents an interleaving pattern converting any index i to another index in the range of [0, N_{cbps}−1]. After the first stage, the output bits index k′ is represented as indicated in Equations (5) and (6) as follows:

$$\begin{matrix}b = {π}_{ac} ( {N}_{sd} , {N}_{bpscs} , {l}_{ss} , {N}_{ss} , mod ( k , {N}_{cbps} ) ) , & ( 5 ) \\ {k}^{′} = b + m \cdot {N}_{cbps} , m = ⌊ \frac{k}{{N}_{cbps}} ⌋ , \\ where k ∈ [ 0 , 4 \cdot {N}_{cbps} - 1 ] , {k}^{′} ∈ [ 0 , 4 \cdot {N}_{cbps} - 1 ] . & ( 6 )\end{matrix}$$

The first interleaver block 103 includes an output 123, the second interleaver block 105 includes an output 125, the third interleaver block 107 includes an output 127, and the fourth interleaver block 109 includes an output 129 that outputs the result of the first stage of the present disclosure to the matrix 111.

The matrix 111 includes a first input connected to the output 123 of the first interleaver block 103, a second input connected to the output 125 of the second interleaver block 105, a third input connected to the output 127 of the third interleaver block 107, a fourth input connected to the output 129 of the fourth interleaver block 109, and an output 131. Output bits from the first interleaver block 103, the second interleaver block 105, the third interleaver block 107, and the fourth interleaver block 109 are stored (e.g. reshaped) in the matrix 111, where the dimension of the output of each of the first interleaver block 103, the second interleaver block 105, the third interleaver block 107, and the fourth interleaver block 109 is N_{bpscs} by N_{sd}, and where the dimension of the matrix 111 is N_{bpscs} by 4N_{sd}.

The permuter 133, which performs the second stage of the present disclosure, includes an input connected to the output 131 of the matrix 111 and an output 135. Consecutive N_{bpscs} bits from the first interleaver block 103, the second interleaver block 105, the third interleaver block 107, and the fourth interleaver block 109 that are stored in the matrix 111 are permuted by the permuter 133. In an embodiment of the present disclosure, a permutation function π₄(m), m∈[0,3] may be used, where the permutation is a bit reverse permutation as in Table 1 below. However, the present disclosure is not limited thereto.

TABLE 1

| | | | | |
|---|---|---|---|---|
| m | 0 | 1 | 2 | 3 |
| π₄(m) | 0 | 2 | 1 | 3 |

After the second stage of the present disclosure, the output bit index k″ may be represented by Equation (7) as follows:

$${k}^{″} = ( 4 \cdot ⌊ \frac{b}{{N}_{bpscs}} ⌋ + {π}_{4} ( m ) ) \cdot {N}_{bpscs} + mod ( b , {N}_{bpscs} ) . \qquad ( 7 )$$

After the second stage of the present disclosure, all consecutive N_{bpscs} bits remain together and are loaded on the same subcarrier. Thus, the second stage of the present disclosure may be viewed as a subcarrier mapping (e.g. loading QAM symbol to subcarriers) before an Inverse FFT (IFFT) operation. Also, after the second stage of the present disclosure, the bit order within each sub-block remains unchanged. These two properties of the present disclosure may be used to reduce the interleaving/deinterleaving memory requirement.

In addition, all bits within each sub block will be mapped to a group of subcarriers. For an FFT (for a receiving operation) with bit reverse order output or an IFFT (for a transmission operation) with bit reverse order input, all of the consecutive bits will be within the same sub block. Thus, the deinterleaving/interleaving is only performed within a sub block, which only requires a quarter of the total interleaving size.

After a bit reverse operation, all of the (bit reversed) indexes for one sub block are within the same range, because the present disclosure maps all of the bits from the same block to a group of subcarriers that have the same value of operation. The IEEE 802.11ac standard cannot achieve this.

In an embodiment of the present disclosure, the first stage of the present disclosure may be performed in two stages instead of one by, for example, separating the per spatial stream bit position rotation. In this case, the interleaving among blocks can still apply before the per spatial stream bit position rotation without causing any difference in terms of overall permutation results.

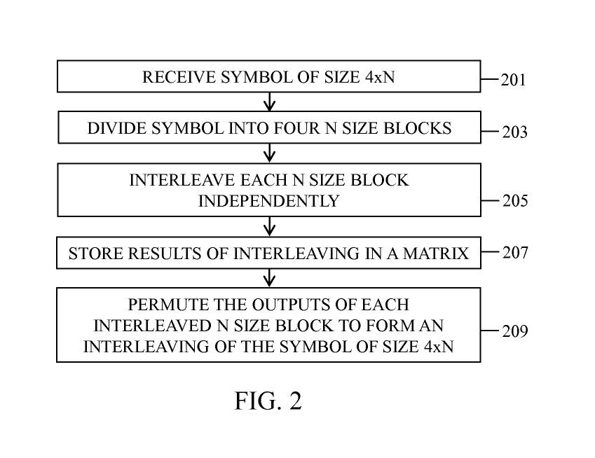

FIG. 2 is a flowchart of a method of an interleaving on an interleaver according to an embodiment of the present disclosure.

Referring to FIG. 2, a symbol of bit length 4×N is received in a register in step 201. In an embodiment of the present disclosure, the received symbol is an OFDM symbol. However, the present disclosure is not limited to receiving an OFDM symbol.

In an embodiment of the present disclosure, the received symbol may be an OFDM symbol that is 4×N_{cbps} bits as in the IEEE 802.11ax standard, where N_{cbps} is a number of encoded bits transmitted in one OFDM symbol in accordance with the IEEE 802.11ac standard, and where 4×N_{sd} is a number of data subcarriers in one OFDM symbol of the present disclosure as in the IEEE 802.11ax standard, which is four times greater than the OFDM symbol of the IEEE 802.11ac standard.

In step 203, the received symbol is divided into four N size blocks. In an embodiment of the present disclosure, 4×N_{cbps} bits are received and divided into four blocks, where each block is N_{cbps} bits. However, the present disclosure is not limited thereto.

In step 205, each of the N size blocks are interleaved independently by an interleaver. In an embodiment of the present disclosure, each interleaving may be the interleaving function defined in the IEEE 802.11ac standard. However, the present disclosure is not limited thereto.

In step 207, the results of interleaving each of the N size blocks are stored in a matrix. Output bits from the independent interleavings are stored (e.g. reshaped) in the matrix, where the dimension of the output of each of the first interleaver block 103, the second interleaver block 105, the third interleaver block 107, and the fourth interleaver block 109 is N_{bpscs} by N_{sd}, and where the dimension of the matrix 111 is N_{bpscs} by 4N_{sd}.

In step 209, the bits stored in the matrix are permuted in a permuter. Consecutive N_{bpscs} bits from the interleavings that are stored in the matrix 111 are permuted by the permuter. In an embodiment of the present disclosure, a permutation function π4(m), m∈[0,3] may be used, where the permutation is a bit reverse permutation as in Table 1 above. However, the present disclosure is not limited thereto.

After the permutation, the output bit index k″ may be represented by Equation (7) above.

After the permutation, all consecutive N_{bpscs} bits remain together and are loaded on the same subcarrier. Thus, the permutation may be viewed as a subcarrier mapping (e.g. loading QAM symbol to subcarriers) before an Inverse FFT (IFFT) operation. Also, after the permutation, the bit order within each sub-block remains unchanged. These two properties of the present disclosure may be used to reduce the interleaving/deinterleaving memory requirement.

In addition, all bits within each sub block will be mapped to a group of subcarriers. For an FFT (for a receiving operation) with bit reverse order output or an IFFT (for a transmission operation) with bit reverse order input, all of the consecutive bits will be within the same sub block. Thus, the deinterleaving/interleaving is only performed within a sub block, which only requires a quarter of the total interleaving size.

After a bit reverse operation, all of the (bit reversed) indexes for one sub block are within the same range, because the present disclosure maps all of the bits from the same block to a group of subcarriers that have the same value of operation. The IEEE 802.11ac standard cannot achieve this.

The present disclosure may be implemented in a chipset for an interleaver. The chipset is configured to receive, by a register, a symbol, interleave, by a first interleaver block, a first quarter of the symbol; interleave, by a second interleaver block, a second quarter of the symbol; interleave, by a third interleaver block, a third quarter of the symbol; interleave, by a fourth interleaver block, a fourth quarter of the symbol; store, by a matrix, the interleavings of the first interleaver block, the second interleaver block, the third interleaver block, and the fourth interleaver block; and permute, by a permuter, the interleavings stored in the matrix.

The chipset may be further configured to receive a 4×N_{cbps} bit Orthogonal Frequency Division Multiplexing (OFDM) symbol, where N_{cbps} is a number of encoded bits transmitted in one OFDM symbol in accordance with the IEEE 802.11ac standard.

Interleaving, by each of the first interleaver block, the second interleaver block, the third interleaver block, and the fourth interleaver block in the chipset is performed in accordance with the IEEE 802.11ac standard.

The chipset may be further configured to store, by the matrix, the interleavings of the first interleaver block, the second interleaver block, the third interleaver block, and the fourth interleaver block an N_{bpscs} by N_{sd} dimension matrix, where N_{bpscs} is a number of bits carried in one subcarrier, and where N_{sd} is a number of data subcarriers in one Orthogonal Frequency Division Multiplexing (OFDM) symbol in accordance with the IEEE 802.11ac standard.

The permutation performed by the permuter in the chipset is a bit reverse permutation on the interleavings stored in the matrix.

Permuting, by the permuter, the interleavings stored in the matrix by the chipset provides an output bit index according to Equation (8) as follows:

$${k}^{″} = ( 4 \cdot ⌊ \frac{b}{{N}_{bpscs}} ⌋ + {π}_{4} ( m ) ) \cdot {N}_{bpscs} + mod ( b , {N}_{bpscs} ) . \qquad ( 8 )$$

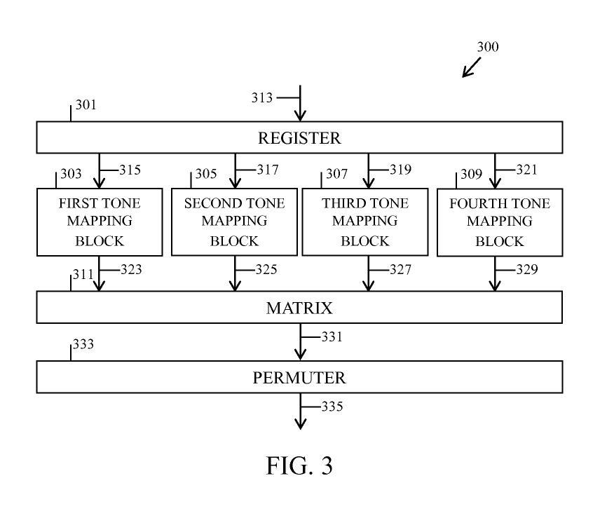

FIG. 3 is a block diagram of a tone mapper 300 according to an embodiment of the present disclosure.

Referring to FIG. 3, the apparatus 300 includes a register 301, a first tone mapping block 303, a second tone mapping block 305, a third tone mapping block 307, a fourth tone mapping block 309, a matrix 311, and a permuter 333.

The register 301 includes an input 313 for receiving a symbol of bit length 4×N, a first output 315, a second output 317, a third output 319, and a fourth output 321, where each of the first output 315, the second output 317, the third output 319, and the fourth output 321 outputs N bits of the received 4×N bit symbol. In an embodiment of the present disclosure, the received symbol is an OFDM symbol. However, the present disclosure is not limited to receiving an OFDM symbol.

In an embodiment of the present disclosure, the received symbol may be an OFDM symbol that is 4×N_{cbps} bits as in the IEEE 802.11ax standard, where N_{cbps} is a number of encoded bits transmitted in one OFDM symbol for the IEEE 802.11ac standard, and where 4×N_{sd} is a number of data subcarriers in one OFDM symbol of the present disclosure as in the IEEE 802.11ax standard, which is four times greater than the OFDM symbol of the IEEE 802.11ac standard. In this case, each of the first output 315, the second output 317, the third output 319, and the fourth output 321 of the register 301 outputs N_{cbps} bits of the 4×N_{cbps} bits received by the register 301. However, the present disclosure is not limited thereto.

Each of the first tone mapping block 303, the second tone mapping block 305, the third tone mapping block 307, and the fourth tone mapping block 309 includes an input connected to the first output 315, the second output 317, the third output 319, and the fourth output 321, respectively, for receiving N bits from one of the outputs of the register 301. In an embodiment of the present invention, each of the first tone mapping block 303, the second tone mapping block 305, the third tone mapping block 307, and the fourth tone mapping block 309 may receive N_{cbps} bits from the first output 315, the second output 317, the third output 319, and the fourth output 321 of the register 301.

In FIG. 3, the first tone mapping block 303, the second tone mapping block 305, the third tone mapping block 307, and the fourth tone mapping block 309 sequentially receive 4×N bits from the first output 315, the second output 317, the third output 319, and the fourth output 321 of the register 301. However, the present invention is not limited thereto.

Each of the first tone mapping block 303, the second tone mapping block 305, the third tone mapping block 107, and the fourth tone mapping block 309 may implement the interleaving function defined in the IEEE 802.11 ac standard. However, the present disclosure is not limited thereto.

In the IEEE 802.11ax standard, 4×N_{cbps} is the number of encoded bits transmitted in one OFDM symbol in accordance with the IEEE 802.11ax standard, and 4×N_{sd} is the number of data subcarriers in one OFDM symbol in accordance with the IEEE 802.11ax standard.

Tone mapping in the IEEE 802.11ax standard (i.e., for a 4×N_{sd} sized OFDM symbol) is performed in two stages. In the first stage, the encoded bits are grouped into four blocks, and k^{th} (input index) bit belongs to block

$$m = ⌊ \frac{k}{{N}_{cbps}} ⌋ ,$$

k∈[0,4·N_{cbps}−1], m∈[0,3].

Each block is mapped using the mapping pattern defined in accordance with the IEEE 802.11ac standard using the quadruplet (N_{sd},N_{bpscs},iₛₛ,Nₛₛ), where N_{cbps} is a number of encoded bits transmitted in one OFDM symbol in accordance with the IEEE 802.11ac standard, N_{bpscs} is a number of bits carried in one subcarrier, which indicates a modulation order, N_{sd} is a number of data subcarriers in one OFDM symbol in accordance with the IEEE 802.11ac standard, Nₛₛ is a number of spatial streams, iₛₛ is a spatial stream index, where mapping is done per spatial stream separately, and fₛ is a subcarrier spacing in accordance with the IEEE 802.11ac standard.

The mapping function of the IEEE 802.11ac standard includes three permutations. The first permutation is given by the rule shown in Equation (9) below.

$$i = {N}_{ROW} ( k mod {N}_{COL} ) + ⌊ \frac{k}{{N}_{COL}} ⌋ , k = 0 , 1 , … , {N}_{cbpssi} - 1 , \qquad ( 9 )$$

where i is an index of a mapped bit after the first permutation, N_{ROW} is a row number of rows in the mapping function, k is an index of a bit before being mapped, N_{COL} is a number of columns in the mapping function, N_{cbpssi} is a number of encoded bits per symbol per spatial stream per binary convolution code mapping block, and └x┘ is a floor function that provides the largest integer less than or equal to x.

The second permutation of the IEEE 802.11ac standard is given by the rule shown in Equation (10) below.

$$j = s ⌊ \frac{i}{s} ⌋ + ( i + {N}_{cbpssi} - ⌊ \frac{{N}_{COL} \times i}{{N}_{cbpssi}} ⌋ ) mod s , \\ i = 0 , 1 , … , {N}_{cbpssi} - 1 , \qquad ( 10 )$$

where j is an index of a mapped bit after the second permutation, and s is a number of bits assigned to a single axis of a constellation point in a spatial stream.

If 2≦Nₛₛ≦4, the third permutation of the IEEE 802.11ac standard is a frequency rotation applied to the output of the second permutation as shown in Equation (11) below.

$$r = \{ j - [ ( 2 ( {i}_{ss} - 1 ) ) mod 3 + 3 ⌊ \frac{{i}_{ss} - 1}{3} ⌋ ] \times {N}_{ROT} \times {N}_{bpscs} \} mod {N}_{cbpssi} , \\ j = 0 , 1 , … , {N}_{cbpssi} - 1 , {i}_{ss} = 1 , 2 , … , {N}_{ss} , \qquad ( 11 )$$

where r is an index of a mapped bit after the third permutation, and N_{ROT} is a parameter for the frequency rotation.

If Nₛₛ>4, the third permutation of the IEEE 802.11ac standard is a frequency rotation applied to the output of the second permutation as shown in Equation (12) below.

r={j−J(iₛₛ)×N_{ROT}×N_{bpscs}}mod N_{cbpssi}, j=0,1, . . . , N_{cbpssi}−1,iₛₛ=1,2, . . . ,Nₛₛ (12)

where r is an index of a mapped bit after the third permutation, and J(iₛₛ) is an integer.

The parameterized permutation function defined by the IEEE 802.11ac standard is denoted as π_{ac}_{_}_{tonemapping}(N_{sd},N_{bpscs},lₛₛ,Nₛₛi), i ∈[0,N_{cbps}−1],lₛₛ∈[0,Nₛₛ−1]. This represents a mapping pattern converting any index i to another index in the range of [0, N_{cbps}−1]. After the first stage, the output bits index k′ is represented as indicated in Equations (13) and (14) as follows:

$$\begin{matrix}b = {π}_{ac \_ tonemapping} ( {N}_{sd} , {N}_{bpscs} , {l}_{ss} , {N}_{ss} , mod ( k , {N}_{cbps} ) ) , & ( 13 ) \\ {k}^{′} = b + m \cdot {N}_{cbps} , m = ⌊ \frac{k}{{N}_{cbps}} ⌋ , \\ where k ∈ [ 0 , 4 \cdot {N}_{cbps} - 1 ] , {k}^{′} ∈ [ 0 , 4 \cdot {N}_{cbps} - 1 ] . & ( 14 )\end{matrix}$$

The first tone mapping block 303 includes an output 323, the second tone mapping block 305 includes an output 325, the third tone mapping block 307 includes an output 327, and the fourth tone mapping block 309 includes an output 129 that outputs the result of the first stage of the present disclosure to the matrix 311.

The matrix 311 includes a first input connected to the output 323 of the first tone mapping block 303, a second input connected to the output 325 of the second tone mapping block 305, a third input connected to the output 327 of the third tone mapping block 307, a fourth input connected to the output 329 of the fourth tone mapping 309, and an output 331. Output bits from the first tone mapping block 303, the second tone mapping block 305, the third tone mapping block 307, and the fourth tone mapping block 309 are stored (e.g. reshaped) in the matrix 311, where the dimension of the output of each of the first tone mapping block 303, the second tone mapping block 305, the third tone mapping block 307, and the fourth tone mapping block 309 is N_{bpscs} by N_{sd}, and where the dimension of the matrix 311 is N_{bpscs} by 4N_{sd}.

The permuter 333, which performs the second stage of the present disclosure, includes an input connected to the output 331 of the matrix 311 and an output 335. Consecutive N_{bpscs} bits from the first tone mapping block 303, the second tone mapping block 305, the third tone mapping block 307, and the fourth tone mapping block 309 that are stored in the matrix 311 are permuted by the permuter 333.

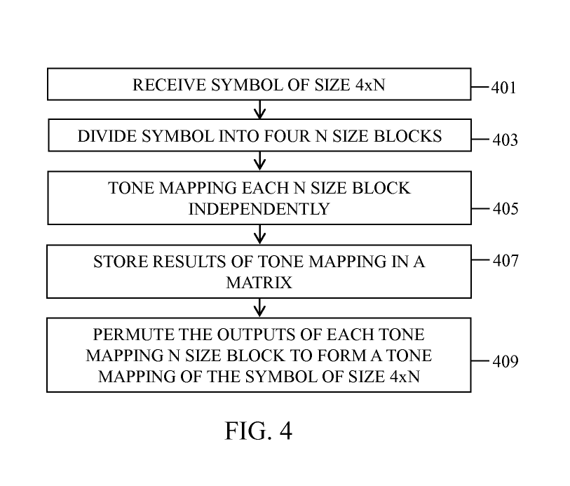

FIG. 4 is a flowchart of a method of tone mapping according to an embodiment of the present disclosure.

Referring to FIG. 4, a symbol of bit length 4×N is received in a register in step 401. In an embodiment of the present disclosure, the received symbol is an OFDM symbol. However, the present disclosure is not limited to receiving an OFDM symbol.

In an embodiment of the present disclosure, the received symbol may be an OFDM symbol that is 4×N_{cbps} bits as in the IEEE 802.11ax standard, where N_{cbps} is a number of encoded bits transmitted in one OFDM symbol in accordance with the IEEE 802.11ac standard, and where 4×N_{sd} is a number of data subcarriers in one OFDM symbol of the present disclosure as in the IEEE 802.11ax standard, which is four times greater than the OFDM symbol of the IEEE 802.11ac standard.

In step 403, the received symbol is divided into four N size blocks. In an embodiment of the present disclosure, 4×N_{cbps} bits are received and divided into four blocks, where each block is N_{cbps} bits. However, the present disclosure is not limited thereto.

In step 405, each of the N size blocks are tone mapped independently by a tone mapper (e.g. an interleaver). In an embodiment of the present disclosure, each tone mapping may be the interleaving function defined in the IEEE 802.11ac standard. However, the present disclosure is not limited thereto.

In step 407, the results of tone mapping each of the N size blocks are stored in a matrix. Output bits from the independent tone mappings are stored (e.g. reshaped) in the matrix, where the dimension of the output of each of the first tone mapping block 303, the second tone mapping block 305, the third tone mapping block 307, and the fourth tone mapping block 309 is N_{bpscs} by N_{sd}, and where the dimension of the matrix 311 is N_{bpscs} by 4N_{sd}.

In step 409, the bits stored in the matrix are permuted in a permuter. Consecutive N_{bpscs} bits from the tone mappings stored in the matrix 311 are permuted by the permuter.

The present disclosure may be implemented in a chipset for a tone mapper. The chipset is configured to receive, by a register, a symbol, tone map, by a first tone mapping block, a first quarter of the symbol; tone map, by a second tone mapping block, a second quarter of the symbol; tone map, by a third tone mapping block, a third quarter of the symbol; tone map, by a fourth tone mapping block, a fourth quarter of the symbol; store, by a matrix, the tone mappings of the first tone mapping block, the second tone mapping block, the third tone mapping block, and the fourth tone mapping block; and permute, by a permuter, the tone mappings stored in the matrix.

The chipset may be further configured to receive a 4×N_{cbps} bit Orthogonal Frequency Division Multiplexing (OFDM) symbol, where N_{cbps} is a number of encoded bits transmitted in one OFDM symbol in accordance with the IEEE 802.11ac standard.

Tone mapping, by each of the first tone mapping block, the second tone mapping block, the third tone mapping block, and the fourth tone mapping block in the chipset is performed in accordance with the IEEE 802.11ac standard.

The chipset may be further configured to store, by the matrix, the tone mappings of the first tone mapping block, the second tone mapping block, the third tone mapping block, and the fourth tone mapping block an N_{bpscs} by N_{sd} dimension matrix, where N_{bpscs} is a number of bits carried in one subcarrier, and where N_{sd} is a number of data subcarriers in one Orthogonal Frequency Division Multiplexing (OFDM) symbol in accordance with the IEEE 802.11ac standard.

The permutation performed by the permuter in the chipset is a bit reverse permutation on the interleavings stored in the matrix.

This present disclosure is applicable to tone mapping for a low-density parity-check (LDPC) code defined in the IEEE 802.11ac standard. The tone mapping scheme includes a permutation such that consecutive N_{bpscs} bits at the input will remain consecutive after the tone nmapping process. It can be represented with the following Equation (15):

π_{ac}_{_}_{tonemapping}(N_{sd},N_{bpscs},lₛₛ,Nₛₛ,i),i∈[0,N_{cbps}−1],lₛₛ∈[0,Nₛₛ−1] (15)

The present disclosure is applicable to the IEEE 802.11 standard and maintains all of its properties because it is independent of the nature of function π_{ac}_{_}_{tonemapping}.

After tone mapping in step 405, the output bits from each tone mapping block are reshaped into N_{bpscs} by N_{sd}, matrix. Accordingly, N_{bpscs} bits from each column will be allocated to one subcarrier. Essentially, the second stage processing is to map these columns to a group of subcarriers.

There are a total of 4 blocks of N_{sd}, where Cₘ∈[0,N_{sd}−1],m∈[0,3] is the column index in the m^{th} block. A tuple of 4×N_{sd} subcarrier indices is generated, which are consecutive, not necessarily beginning at index 0 (for example, subcarrier indices 6 to 5+4×N_{sd}). These subcarrier indices may be grouped into four tuples [symbol] _{q}={Iₜ,mod(Iₜ,4)=q,t∈[0,N_{sd}−1],q∈[0,3]}, where the size S( [symbol] _{q}) is denoted as the number of elements in the tuple, where S( [symbol] _{q})=N_{sd},∀q∈[0,3]. Each tuple has an ordered indices Iₜ having the same modulo 4 value and Iₜ<Iₜ₊₁. Therefore, the index Cₘ may be mapped to Iₜ in [symbol] _{π}_{₄}₍ₘ₎.

However, in the IEEE 802.11ac standard, the available subcarriers are not all consecutive, because some subcarriers are used for other purposes. For example, the subcarrier indices may be 5-11, 13-25, 27-32, 34-39, 41-53, and 55-61. The condition of interest is that the missing indices are arranged in such a way that the tuples [symbol] ₀, [symbol] ₁, [symbol] ₂, [symbol] ₃ are no longer of equal size. The following method accounts for this.

For any [symbol] _{q}, three tuples F_{q}={f},N_{q}={n}, L_{q}={l} may be generated from the original tuple [symbol] _{q} so that [symbol] _{q}={F_{q},N_{q},L_{q}}. Within each tuple F_{q}, N_{q}, and L_{q} the elements are ordered, and the tuple [symbol] _{q} is ordered between the three tuples F_{q}, N_{q}, and L_{q}.

The generation or partition of the three tuples depends on the desired size S(F_{q}) and S(N_{q}). Since S( [symbol] _{q}) is known, the selection of S(F_{q}) and S(N_{q}) determines S(L_{q}).

The partition into three tuples is based on the ordering of the transferred index. The index transfer function is defined as a bit reverse (e.g. y=br(x)) of any non-negative integer number, where x=Σₜ₌₀^{N}^{_{b}}bₜ×2^{t},bₜ=[0,1], where x can be represented by a binary sequence bₜ,t∈[0,N_{b}]; and the bit reverse index transfer can be represented as y=br(x)=Σₜ₌₀^{N}^{_{b}}b_{(N}_{_{b}}₋ₜ₎×2^{t}. The partition is represented by Equation (16) as the follows:

br(f∈F_{q})<br(n∈N_{q})<br(l∈L_{q}),∀q (16)

Because of the bit reverse transfer function, br(Iₜ∈ [symbol] ₀)<br(Iₜ∈ [symbol] ₂)<br(Iₜ∈ [symbol] ₁)<br(Iₜ∈ [symbol] ₃).

Although the tuples [symbol] ₀, [symbol] ₁, [symbol] ₂, [symbol] ₃ might not have the same size, the sum of their sizes are 4×N_{sd}. A certain partition of any [symbol] _{q} by selecting the tuple size for each F_{q}, N_{q}, L_{q}, four tuples [symbol] _{q},q∈[0,3] may be generated, where br(Iₜ∈ [symbol] ₀)<br(Iₜ∈ [symbol] ₁)<br(Iₜ∈ [symbol] ₂)<br(Iₜ∈ [symbol] ₃) and ( [symbol] ₀, [symbol] ₁, [symbol] ₂, [symbol] ₃)=( [symbol] ₀, [symbol] ₁, [symbol] ₂, [symbol] ₃) and S( [symbol] _{q})=N_{sd},∀q∈[0,3].

For example, 4×N_{sd} integers may be (1, 2, 3, 5, 6, 7, 10, 11, 16, 17, 18, and 22), where N_{sd} is 3. This tuple may be partitioned into four tuples [symbol] ₀, [symbol] ₁, [symbol] ₂, [symbol] ₃ as [symbol] ₀=(16), [symbol] ₁=(1,5,17), [symbol] ₂=(2,6,10,18,22), and [symbol] ₃=(3,7,11).

The four tuples may be concatenated. Then, four tuples may be constructed as [symbol] ₀=(16,1,5), [symbol] ₁=(17,2,6), [symbol] ₂=(10,18,22), and [symbol] ₃=(3,7,11).

In addition, the IEEE 802.11ac standard may be used as another example of generating four tuples [symbol] _{q} from [symbol] ₀, [symbol] ₁, [symbol] ₂, [symbol] ₃. In the IEEE 802.11ac standard, S( [symbol] ₀)=S( [symbol] ₂)=N_{sd}−Nₚ, S( [symbol] ₁)=S( [symbol] ₃)=N_{sd}+Nₚ, where Nₚ is number of subcarriers taken out of tuples [symbol] ₀ and [symbol] ₂. [symbol] ₀, [symbol] ₁, [symbol] ₂, and [symbol] ₃ may be partitioned so that [symbol] ₀ is a tuple, [symbol] ₂=(F₂,N₂,L₂), where S(F₂)=Nₚ,S(N₂)=N_{sd}−2Nₚ, S(L₂)=0, [symbol] ₁=(F₁,N₁,L₁), where S(F₁)=2Nₚ,S(N₁)=N_{sd}−Nₚ, S(L₁)=0, and [symbol] ₃=(F₃,N₃,L₃), where S(F₃)=Nₚ,S(N₃)=N_{sd},S(L₃)=0. Then, [symbol] ₀=( [symbol] ₀,F₂), [symbol] ₁=(N₂,F₁), [symbol] ₂=(N₁,F₃), and [symbol] ₃=(N₃).

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. An apparatus for an interleaver, the apparatus comprising:
a register, including an input, a first output, a second output, a third output, and a fourth output;
a first interleaver block, including an input connected to the first output of the register, and an output;
a second interleaver block, including an input connected to the second output of the register, and an output;
a third interleaver block, including an input connected to the third output of the register, and an output;
a fourth interleaver block, including an input connected to the fourth output of the register, and an output;
a matrix, including a first input connected to the output of the first interleaver block, a second input connected to the output of the second interleaver block, a third input connected to the output of the third interleaver block, a fourth input connected to the output of the fourth interleaver block, and an output; and
a permuter, including an input connected to the output of the matrix, and an output.

2. The apparatus of claim 1, wherein the register is configured to receive a 4×N_{cbps} bit Orthogonal Frequency Division Multiplexing (OFDM) symbol, where N_{cbps} is a number of encoded bits transmitted in one OFDM symbol in accordance with an Institute for Electrical and Electronics Engineers (IEEE) 802.11ac standard.

3. The apparatus of claim 1, wherein each of the first interleaver block, the second interleaver block, the third interleaver block, and the fourth interleaver block is configured to implement an interleaving function of an Institute for Electrical and Electronics Engineers (IEEE) 802.11ac standard.

4. The apparatus of claim 1, wherein the matrix is configured to store an N_{bpscs} by N_{sd} dimension matrix, where N_{bpscs} is a number of bits carried in one subcarrier, and where N_{sd} is a number of data subcarriers in one Orthogonal Frequency Division Multiplexing (OFDM) symbol in accordance with an Institute for Electrical and Electronics Engineers (IEEE) 802.11ac standard.

5. The apparatus of claim 1, wherein the permuter is configured to perform a bit reverse permutation.

6. The apparatus of claim 1, wherein the permuter is configured to provide an output bit index according to:
$${k}^{″} = ( 4 \cdot ⌊ \frac{b}{{N}_{bpscs}} ⌋ + {π}_{4} ( m ) ) \cdot {N}_{bpscs} + mod ( b , {N}_{bpscs} ) .$$

7. The apparatus of claim 1, wherein each of the first interleaver block, the second interleaver block, the third interleaver block, and the fourth interleaver block is further configured to apply before a per spatial stream bit position rotation.

8. A method of an interleaver, the method comprising:
receiving, by a register, a symbol;
interleaving, by a first interleaver block, a first quarter of the symbol;
interleaving, by a second interleaver block, a second quarter of the symbol;
interleaving, by a third interleaver block, a third quarter of the symbol;
interleaving, by a fourth interleaver block, a fourth quarter of the symbol;
storing, by a matrix, the interleavings of the first interleaver block, the second interleaver block, the third interleaver block, and the fourth interleaver block; and
permuting, by a permuter, the interleavings stored in the matrix.

9. The method of claim 8, wherein receiving, by the register, a symbol is comprised of receiving a 4×N_{cbps} bit Orthogonal Frequency Division Multiplexing (OFDM) symbol, where N_{cbps} is a number of encoded bits transmitted in one OFDM symbol in accordance with an Institute for Electrical and Electronics Engineers (IEEE) 802.11ac standard.

10. The method of claim 8, wherein interleaving by each of the first interleaver block, the second interleaver block, the third interleaver block, and the fourth interleaver block is comprised of interleaving in accordance with an Institute for Electrical and Electronics Engineers (IEEE) 802.11ac standard.

11. The method of claim 8, wherein storing, by the matrix, the interleavings of the first interleaver block, the second interleaver block, the third interleaver block, and the fourth interleaver block is comprised of storing an N_{bpscs} by N_{sd} dimension matrix, where N_{bpscs} is a number of bits carried in one subcarrier, and where N_{sd} is a number of data subcarriers in one Orthogonal Frequency Division Multiplexing (OFDM) symbol in accordance with an Institute for Electrical and Electronics Engineers (IEEE) 802.11ac standard.

12. The method of claim 8, wherein permuting, by the permuter, the interleavings stored in the matrix is comprised of performing a bit reverse permutation.

13. The method of claim 8, wherein permuting, by the permuter, the interleavings stored in the matrix the permuter provides an output bit index according to:
$${k}^{″} = ( 4 \cdot ⌊ \frac{b}{{N}_{bpscs}} ⌋ + {π}_{4} ( m ) ) \cdot {N}_{bpscs} + mod ( b , {N}_{bpscs} ) .$$

14. The method of claim 8, wherein interleaving, by each of the first interleaver block, the second interleaver block, the third interleaver block, and the fourth interleaver block, is comprised of interleaving before a per spatial stream bit position rotation.

15. A method of tone mapping in a tone mapper, the method comprising:
receiving, by a register, a symbol;
tone mapping, by a first tone mapping block, a first quarter of the symbol;
tone mapping, by a second tone mapping block, a second quarter of the symbol;
tone mapping, by a third tone mapping block, a third quarter of the symbol;
tone mapping, by a fourth tone mapping block, a fourth quarter of the symbol;
storing, by a matrix, the tone mappings of the first tone mapping block, the second tone mapping block, the third tone mapping block, and the fourth tone mapping block; and
permuting, by a permuter, the tone mappings stored in the matrix.

16. The method of claim 15, wherein receiving, by the register, a symbol is comprised of receiving a 4×_{cbps} bit Orthogonal Frequency Division Multiplexing (OFDM) symbol, where N_{cbps} is a number of encoded bits transmitted in one OFDM symbol in accordance with an Institute for Electrical and Electronics Engineers (IEEE) 802.11ac standard.

17. The method of claim 15, wherein tone mapping by each of the first tone mapping block, the second tone mapping block, the third tone mapping block, and the fourth tone mapping block is comprised of interleaving in accordance with an Institute for Electrical and Electronics Engineers (IEEE) 802.11ac standard.

18. The method of claim 15, wherein storing, by the matrix, the tone mappings of the first tone mapping block, the second tone mapping block, the third tone mapping block, and the fourth tone mapping block is comprised of storing an N_{bpscs} by N_{sd} dimension matrix, where N_{bpscs} is a number of bits carried in one subcarrier, and where N_{sd} is a number of data subcarriers in one Orthogonal Frequency Division Multiplexing (OFDM) symbol in accordance with an Institute for Electrical and Electronics Engineers (IEEE) 802.11ac standard.

19. The method of claim 15, wherein permuting, by the permuter, the tone mappings stored in the matrix is comprised of:
generating four tuples G_{q} of 4×N_{sd} subcarrier blocks stored in the matrix, where q=0, 1, 2, and 3;
generating three tuples F_{q}, N_{q}, and L_{q} for each of the four tuples, where G_{q}=(F_{q}, N_{q}, L_{q});
and
reversing the bits of the three tuples F₁, N_{q}, and L_{q} for each of the four tuples G_{q}.

20. The method of claim 19, wherein the sizes of F_{q} and N_{q} are selected, and where the size of L_{q} is determined based on the selections of the sizes of F_{q} and N_{q}.
